(19) United States
(12) Patent Application Publication
(10) Pub. No.: US 2014/0363009 A1
(43) Pub. Date: Dec. 11, 2014

(54) ACTIVE NOISE CANCELLATION METHOD FOR MOTORCYCLES

(71) Applicant: Lloyd Trammell, Thousand Oaks, CA (US)

(72) Inventor: Lloyd Trammell, Thousand Oaks, CA (US)

(73) Assignee: Max Sound Corporation, La Jolla, CA (US)

(21) Appl. No.: 14/273,304

(22) Filed: May 8, 2014

Related U.S. Application Data
(60) Provisional application No. 61/821,035, filed on May 8, 2013.

(51) Int. Cl. H04R 3/00

(52) U.S. Cl. CPC H04R 3/002
USPC 381/71.1

(57) ABSTRACT

A Noise Cancellation Process for a motorcycle comprising an input audio source. Input audio source is combined in a mixer. Noise analyzer analyzes output from the mixer for amplitude and harmonic content. A replicate wave that is identical to the input audio source is created. The phase of the replicate wave is changed by −180 degrees. Amplitude from the Noise Analyzer is monitored and amplitude of the replicated wave is matched to the original wave. The phase of the replicate wave and the input audio wave are combined to create Audio Out. Audio Out is played on the system.

### CROSS-REFERENCE TO RELATED PATENT APPLICATIONS

Embodiments of the present invention relate to U.S. Provisional Application Ser. No. 61/821,035, filed May 8, 2013, entitled “MOTORCYCLE NOISE REDUCTION”, the contents of which are incorporated by reference herein and which is a basis for a claim of priority.

### BACKGROUND OF THE INVENTION

The present invention relates to a method and device for enhancing an audio source by reducing and eliminating background and other ambient noise in the sound wave, especially suitable for motorcycles.

Active noise control (ANC), also known as noise cancellation, or active noise reduction (ANR), is a method for reducing unwanted sound by the addition of a second sound specifically designed to cancel the first.

Sound is a pressure wave, which consists of a compression phase and a rarefaction phase. A noise-cancellation speaker emits a sound wave with the same amplitude but with inverted phase (also known as anti-phase) to the original sound. The waves combine to form a new wave, in a process called interference, and effectively cancel each other out—an effect which is called phase cancellation.

Modern active noise control is generally achieved through the use of analog circuits or digital signal processing. Adaptive algorithms are designed to analyze the waveform of the background aural or nonaural noise, then based on the specific algorithm generate a signal that will either phase shift or invert the polarity of the original signal. This inverted signal (in antiphase) is then amplified and a transducer creates a sound wave directly proportional to the amplitude of the original waveform, creating destructive interference. This effectively reduces the volume of the perceivable noise.

Riding a motorcycle creates a large amount of wind noise. The noise level can go into to 100 dB+ range, depending on motorcycle speed and weather conditions. This noise inhibits the rider's hearing ability. A helmet with a small sound system installed for listening to music and/or radio communications is the usual method. With this system, the noise from the wind will be lessened by a large amount and the rider will have a more distinct audio experience of the world around him as he travels.

Since the system is dynamic, it will adjust itself in real time to the constantly changing conditions, Meaning that if the rider stops, the system will adjust itself to accommodate for no wind noise. The preferred method of use would be, but not limited to, some type of fairing.

A motorcycle fairing is a shell placed over the frame of some motorcycles, especially racing motorcycles and sport bikes, with the primary purpose to reduce air drag. The secondary functions are the protection of the rider from airborne hazards, noise, and wind-induced hypothermia and of the engine components in the case of an accident. There may be a front fairing, as well as a rear fairing component. A motorcycle windshield may be an integral part of the fairing.¹ FIG. 1 shows a conventional fairing system. ¹http://en.wikipedia.org/wiki/Motorcycle_fairing

A new noise cancelation method and process is required that addresses the above noted deficiencies of the conventional noise reduction methods and systems.

### SUMMARY OF THE INVENTION

The inventive Active Noise Cancellation (ANC) is a dynamic system that analyzes noise by virtue of it's harmonic content, dynamic range, and phase in real time. With this information the ANC will identify noise and sounds that in a given environment and effectively reduce said noise by a large percent. If the noise changes in any way, the ANC will detect this and adjust accordingly. The ANC captures audio from omnidirectional microphones and immediately identifies problem audio areas. It continually “listens” for changes so that if the noise changes, it can produce the same sound with an amount of amplitude needed to cancel or reduce the amount heard in a given area. For example, as the motorcycle accelerates, the sound of the wind will change in amplitude and harmonic content. The ANC will detect this and start working dynamically in real time. Engine sound will be ignored by filtering it out. There will be thresholds and frequency ranges specified for different types of motorcycles to allow for optimum performance.

### BRIEF DESCRIPTION OF THE DRAWINGS

FIG. 1 depicting a conventional Motorcycle Pairing System.

FIG. 2 is a block diagram showing the inventive motorcycle noise reduction according to an exemplary embodiment of the present invention.

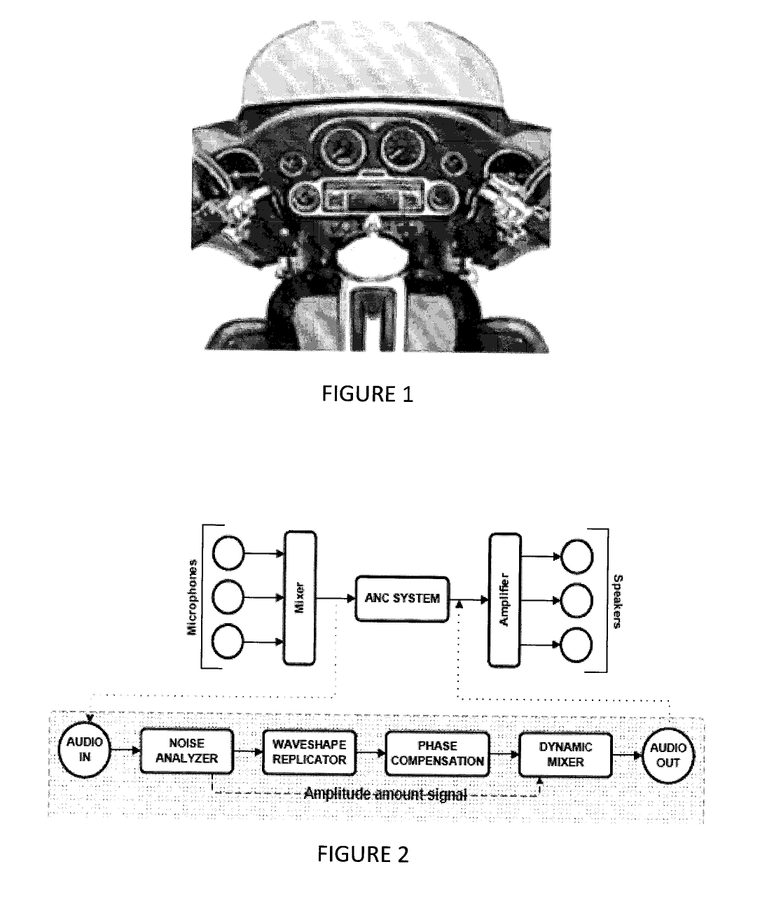

### DETAILED DESCRIPTION OF THE PREFERRED EMBODIMENT(S)

A Noise Cancellation Process for a motorcycle comprising an input audio source. Input audio source is combined in a mixer. Noise analyzer analyzes output from the mixer for amplitude and harmonic content. A replicate wave that is identical to the input audio source is created. The phase of the replicate wave is changed by −180 degrees. Amplitude from the Noise Analyzer is monitored and amplitude of the replicated wave is matched to the original wave. The phase of the replicate wave and the input audio wave are combined to create Audio Out.

### Audio Out is Played on the System

The Active Noise Cancellation (ANC) is a dynamic system that analyzes noise by virtue of its harmonic content, dynamic range, and phase in real time. With this information the ANC will identify noise and sounds that in a given environment and effectively reduce said noise by a large percent. If the noise changes in any way, the ANC will detect this and adjust accordingly. In addition, the ANC will do a comparative analysis of any and all overlapping zones and make the necessary computations to cover not only each zone, but the entire area of the combined zones.

The inventive ANC captures audio from an omnidirectional microphone and immediately identifies problem audio areas. It continually “listens” for changes so that if the noise changes, it can produce the same sound with an amount of phase shift and/or amplitude needed to cancel or reduce the amount heard in a given area. For example, as an airplane or automobile accelerates it's engine the sound will change in amplitude and harmonic content. The ANC will detect this and start working dynamically in real time. There will be thresholds and frequency ranges specified for every type of use to allow for optimum performance.

According to an exemplary embodiment of the present invention, mixed from strategically placed microphones is received and sent to the Audio in of the ANC. These microphones are preferably mounted in the top areas of the fairing, below the windshield. Noise Analyzer analyzes the input noise for amplitude and harmonic content. Engine sound will be filtered out of the audio. Waveshape Replicator—creates an identical wave to the original input wave. Phase Compensation—changes the phase of the replicate wave by −180 degrees. Dynamic Mixer—monitors the amplitude amount that is sent from the Noise Analyzer and matches the amplitude of the replicated wave to the original wave. The final replicated wave is then sent to the Audio Out to be played from the system.

What is claimed is:

1. A Noise Cancellation Process for a motorcycle comprising:
Input audio source;
Processing the input audio source by a mixer;
Analyzing output from the mixer for amplitude and harmonic content;
Creating a replicate wave that is identical to the input audio source;
Changing the phase of the replicate wave by −180 degrees;
Monitoring the amplitude amount that is sent from the Noise Analyzer and matching the amplitude of the replicated wave to the original wave;
Combining the phase changed replicate wave with the input audio source to create Audio Out;
Sending Audio Out to be played from the system.

2. The Noise Cancellation Process of claim 1 wherein the input audio source is sound waves from three microphones.

3. The Noise Cancellation process of claim 2 further comprising a fairing.

4. The Noise Cancellation Process of claim 3, wherein the microphones are located in the top areas of the fairing.

5. The Noise Cancellation Process of claim 4, wherein the microphones are of Cardiod type.
